(19) United States
(12) Patent Application Publication
(10) Pub. No.: US 2026/0057535 A1
(43) Pub. Date: Feb. 26, 2026

(54) THREE-DIMENSIONAL INFORMATION GENERATING DEVICE AND THREE-DIMENSIONAL INFORMATION GENERATING METHOD

(71) Applicant: JVCKENWOOD Corporation, Kanagawa (JP)

(72) Inventor: Etsuro MOMIYAMA, Yokohama-shi (JP)

(21) Appl. No.: 19/372,039

(22) Filed: Oct. 28, 2025

Related U.S. Application Data
(63) Continuation of application No. PCT/JP2024/014382, filed on Apr. 9, 2024.

(30) Foreign Application Priority Data
May 10, 2023 (JP) 2023-077667

(51) Int. Cl. G06T 7/55

(52) U.S. Cl. CPC G06T 7/55; G06T 2207/10028; G06T 2207/20212

(57) ABSTRACT

A three-dimensional information generating device includes a first acquisition unit configured to acquire first image information including image information acquired by imaging a subject and distance information corresponding to this image information, a second acquisition unit configured to acquire second image information including at least pixel information, an image composing unit configured to generate a composed image by composing the image information included in the acquired first image information and information included in the second image information, and a point cloud data generating unit configured to generate point cloud data on the basis of the generated composed image and the distance information included in the first image information wherein the image composing unit generates an image in which pixel information of a column or a row in the image information included in the acquired first image information and the pixel information included in the second image information are alternately provided.

### TECHNICAL FIELD

The present invention relates to a three-dimensional information generating device and a three-dimensional information generating method.

### CROSS REFERENCE TO RELATED APPLICATION

Priority is claimed on Japanese Patent Application No. 2023-077667, filed May 10, 2023, the content of which is incorporated herein by reference.

### BACKGROUND ART

Conventionally, a three-dimensional shape of an object present in the real world is acquired, and 3D modeling based on the acquired 3D shape is performed. In order to accurately acquire the three-dimensional shape of an object, there is a technique of acquiring three-dimensional information of a subject from multiple viewpoints using a plurality of range cameras. The three-dimensional information acquired from each of the plurality of range cameras is combined into one piece of three-dimensional information. By acquiring three-dimensional information of a subject from multiple viewpoints using a plurality of range cameras, it is possible to acquire three-dimensional information with higher fidelity than that of a case in which three-dimensional information is acquired from one direction using one camera. As a technique for combining three-dimensional information acquired from a plurality of range cameras into one piece of three-dimensional information, for example, there is a technique described in Patent Document 1 as an example.

### CITATION LIST

### Patent Document

Patent Document 1: Japanese Unexamined Patent Application, First Publication No. H7-174538

### SUMMARY OF INVENTION

According to the conventional technique as described above, relative positions between images are calculated using a plurality of pieces of image data captured at multiple viewpoints, coordinates conversion parameters of the image data are acquired, and the three-dimensional information is joined on the basis of the acquired coordinate conversion parameters to compose the three-dimensional information into one piece of three-dimensional information. However, in order to acquire three-dimensional information with higher fidelity, it is necessary to use a larger number of cameras, and, as the number of cameras increases, the more sufficient hardware resources for a composition process become necessary, and more time becomes necessary. Particularly, in a case in which a dynamic three-dimensional shape of a subject is to be acquired, there is a problem that it becomes difficult to acquire the three-dimensional shape. Furthermore, according to the conventional technique as described above, a plurality of cameras are required, and there is a problem that a large-scale facility such as a studio facility or the like is required.

Thus, the present embodiment is in view of such situations, and an object thereof is to provide a three-dimensional information generating device and a three-dimensional information generating method capable of easily acquiring a three-dimensional shape of a subject using a small number of cameras.

[1] One aspect of this embodiment is a three-dimensional information generating device including: a first acquisition unit configured to acquire first image information including image information acquired by imaging a subject and distance information corresponding to this image information; a second acquisition unit configured to acquire second image information including at least pixel information; an image composing unit configured to generate a composed image by composing the image information included in the acquired first image information and information included in the second image information; and a point cloud data generating unit configured to generate point cloud data on the basis of the generated composed image and the distance information included in the first image information, wherein the image composing unit generates an image in which pixel information of a column or a row in the image information included in the acquired first image information and the pixel information included in the second image information are alternately provided as the composed image.

[2] In addition, one aspect of this embodiment is a three-dimensional information generating method executed by a three-dimensional information generating device, the three-dimensional information generating method including: a first acquisition process of acquiring first image information including image information acquired by imaging a subject and distance information corresponding to this image information; a second acquisition process of acquiring second image information including at least pixel information; an image composing process of generating a composed image by composing the image information included in the acquired first image information and information included in the second image information; and a point cloud data generating process of generating point cloud data on the basis of the generated composed image and the distance information included in the first image information, wherein the image composing process generates an image in which pixel information of a column or a row in the image information included in the acquired first image information and the pixel information included in the second image information are alternately provided as the composed image.

According to this embodiment, a three-dimensional shape of a subject can be easily acquired using a small number of cameras.

### BRIEF DESCRIPTION OF DRAWINGS

FIG. 1 A functional configuration diagram illustrating an example of a functional configuration of a three-dimensional information generating system according to a first embodiment.

FIG. 2 A functional configuration diagram illustrating an example of a functional configuration of a three-dimensional information generating device according to the first embodiment.

FIG. 3 A diagram showing composition of image information according to the first embodiment.

FIG. 4 A flowchart illustrating an example of a series of operations of the three-dimensional information generating device according to the first embodiment.

FIG. 5 A block diagram illustrating an example of an internal configuration of the three-dimensional information generating device according to the first embodiment.

FIG. 6 A functional configuration diagram illustrating an example of a functional configuration of a three-dimensional information acquiring system according to a second embodiment.

FIG. 7 A functional configuration diagram illustrating an example of a functional configuration of a three-dimensional information generating device according to the second embodiment.

FIG. 8 A diagram showing composition of image information according to the second embodiment.

FIG. 9 A diagram showing an offset of distance information according to the second embodiment.

FIG. 10 A diagram showing composition of distance images according to the second embodiment.

FIG. 11 A flowchart illustrating an example of a series of operations of the three-dimensional information generating device according to the second embodiment.

### DESCRIPTION OF EMBODIMENTS

Hereinafter, preferred embodiments of three-dimensional information generating devices and three-dimensional information generating methods according to aspects of the present invention will be described in detail with reference to the attached drawings. The embodiments described below are merely examples, and an embodiment to which the present invention is applied is not limited to the following embodiments. “On the basis of XX” described in the present application means “at least on the basis of XX”, and a case of being on the basis of other elements in addition to XX is included therein. “On the basis of XX” is not limited to a case in which XX is directly used, and a case of being on the basis of a result acquired by performing an arithmetic operation or processing on XX is also included therein. “XX” is an arbitrary element (for example, arbitrary information). Furthermore, in the following drawings, for easily understanding each configuration, the scale and the number in each structure may be configured to be different from the scale and the number in an actual structure.

### First Embodiment

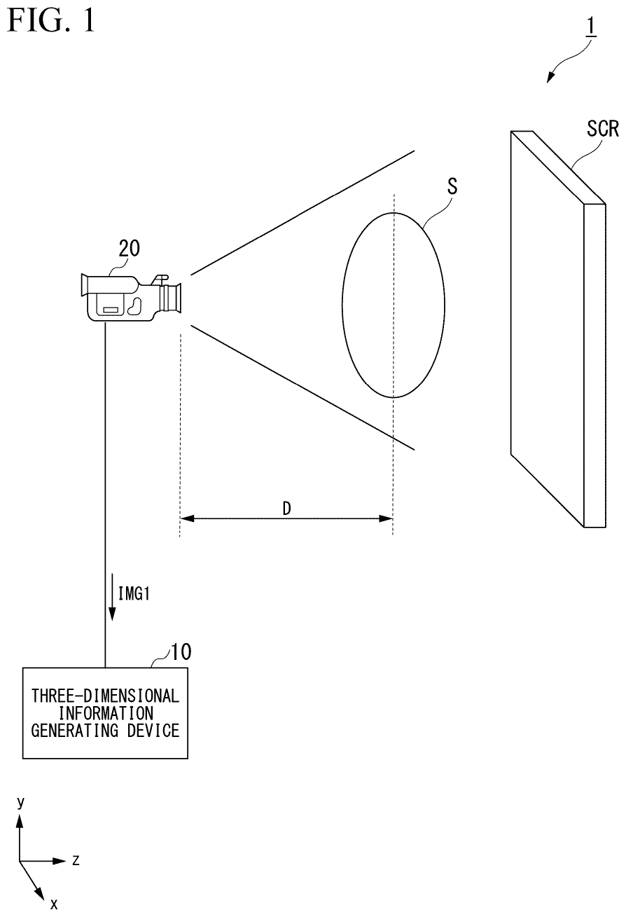

First, a three-dimensional information generating system 1 according to a first embodiment is described with reference to FIGS. 1 to 5.

FIG. 1 is a functional configuration diagram illustrating an example of a functional configuration of the three-dimensional information generating system according to the first embodiment. An example of a functional configuration of the three-dimensional information generating system 1 is described with reference to the drawing. In the following description, the posture of each device included in the three-dimensional information generating system 1 and a positional relation and the like of the devices may be described using a three-dimensional orthogonal coordinate system having an x axis, a y axis, and a z axis.

The three-dimensional information generating system 1 includes a three-dimensional information generating device 10 and an imaging device 20. By including the three-dimensional information generating device 10 and the imaging device 20, the three-dimensional information generating system 1 acquires three-dimensional information of a subject S and generates a three-dimensional model. The imaging device 20 images a subject S from a place that is a distance D away from the subject S in the z-axis direction. Behind the subject S, a screen SCR such as a blue screen or the like may be arranged. In a case in which the three-dimensional shape of a subject S can be easily separated from the background, the screen SCR is not necessary.

The imaging device 20 is a range camera that can acquire three-dimensional information of a subject S. The imaging device 20 acquires three-dimensional information of a subject S by two-dimensionally measuring a distance to the subject S in correspondence with an image (or a video) to be captured. The three-dimensional information of a subject S acquired by the imaging device 20, for example, may be three-dimensional point cloud data. The imaging device 20, for example, by using a time of flight (TOF) method, may two-dimensionally emit light to a subject S and measure a distance on the basis of a time until reflective light is received. The imaging device 20 outputs the acquired three-dimensional information of the subject S to the three-dimensional information generating device 10 as first image information IMG1.

The first image information IMG1 includes image information (for example, an RGB image) acquired by imaging a subject S from a predetermined direction and distance information corresponding to this image information. The distance information included in the first image information IMG1 includes a plurality of pieces of distance information corresponding to coordinate information on an x-y plane. The coordinate information on the x-y plane that is included in this distance information corresponds to a pixel included in an image. Hereinafter, a plurality of pieces of distance information corresponding to coordinate information on the x-y plane may be referred to as a distance image. Although it is preferable to have distance information for each pixel included in an image, one piece of distance information may be included for a plurality of pixels. In other words, the resolution of distance information on the x-y plane may be lower than the resolution of the image information.

In the following description, in a subject S, a face on which the imaging device 20 is present may be referred to as a front face of the subject S, and a face on which the screen SCR is present may be referred to as a rear face of the subject S. The front face and the rear face of a subject S are not specified from the shape of the subject S and are specified on the basis of a positional relation between the imaging device 20 and the subject S. Thus, the first image information IMG1 can be also regarded to include image information of the front face of the subject S and distance information corresponding to this image information.

The three-dimensional information generating device 10 acquires first image information from the imaging device 20. The three-dimensional information generating device 10 generates a three-dimensional model having a three-dimensional shape of a subject S on the basis of the acquired first image information IMG1. The three-dimensional model generated by the three-dimensional information generating device 10, for example, may be point cloud data. Here, the three-dimensional information generating system 1 acquires information of the subject S from one direction using one imaging device 20. Thus, the three-dimensional information generating system 1 cannot sufficiently acquire information of the rear face of the subject S. The three-dimensional information generating device 10 supplements three-dimensional information on the rear face of the subject S on the basis of information acquired from the imaging device 20 and generates a three-dimensional model. This embodiment is not necessarily limited to a case in which only one imaging device 20 is used, and a plurality of imaging devices 20 may be used.

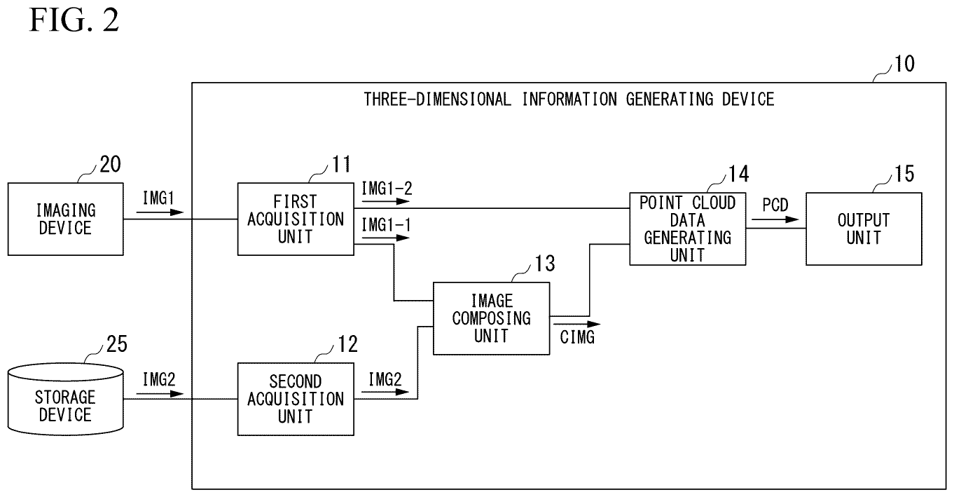

FIG. 2 is a functional configuration diagram illustrating an example of a functional configuration of the three-dimensional information generating device according to the first embodiment. An example of a functional configuration of the three-dimensional information generating device 10 is described with reference to the drawing. The three-dimensional information generating device 10 includes a first acquisition unit 11, a second acquisition unit 12, an image composing unit 13, a point cloud data generating unit 14, and an output unit 15. Each of such functional units, for example, is realized using an electronic circuit. Each of the functional units may include a storage means such as a semiconductor memory, a magnetic hard disk device, or the like on the inside thereof as necessary. Furthermore, each function may be realized using a computer and software.

The first acquisition unit 11 acquires first image information IMG1 from the imaging device 20. The first image information IMG1 includes at least image information acquired by imaging a subject S and distance information corresponding to this image information. The first acquisition unit 11 outputs the image information included in the acquired first image information IMG1 to the image composing unit 13 as first image information IMG1-1. In addition, the first acquisition unit 11 outputs the distance information included in the acquired first image information IMG1 to the point cloud data generating unit 14 as first image information IMG1-2.

The second acquisition unit 12 acquires second image information IMG2 from a storage device 25. The second image information IMG2 includes pixel information used for supplementing the rear face of the subject S. In addition, preferably, the second image information IMG2 may include image information used for supplementing the rear face of the subject S. For example, in a case in which the subject S is a face part of a person, and the front face of this person is imaged by the imaging device 20, pixel information or image information used for supplementing the rear face of the subject S may be color information of the rear face of the subject S or image information of the rear face of the subject S. The color information of the rear face of the subject S, for example, may be color information of hair or the like. In such a case, the second image information IMG2 may include at least information of one color that specifies the color of the hair. In other words, the second image information IMG2 may include at least one piece of pixel information. In addition, the image information used for supplementing the rear face of the subject S may be an image pattern having at least image information of the hair.

The second image information IMG2 does not need to be stored in the storage device 25 in advance. For example, the second image information IMG2 may be acquired by extracting pixel information (color information) of a part of the image information included in the first image information IMG1 acquired by the first acquisition unit 11. In addition, the second image information IMG2 may be acquired by extracting a pattern of a part of the image information included in the first image information IMG1 acquired by the first acquisition unit 11. Furthermore, for the second image information IMG2, an estimated color of the rear face of the subject S may be acquired as the second image information IMG2 by performing image analysis of the first image information IMG1 acquired by the first acquisition unit 11.

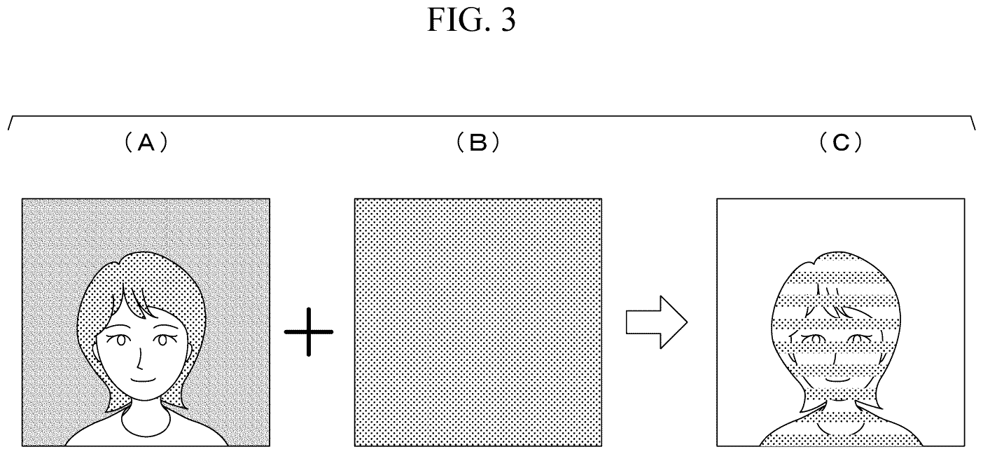

The image composing unit 13 acquires first image information IMG1-1 from the first acquisition unit 11 and acquires second image information IMG2 from the second acquisition unit 12. By composing the image information included in the acquired first image information IMG1-1 and the pixel information or the image information included in the second image information IMG2, the image composing unit 13 generates a composed image. An example of an image composition method performed by the image composing unit 13 is described in detail with reference to FIG. 3.

FIG. 3 is a diagram showing composition of image information according to the first embodiment. An example of a image composition method performed by the image composing unit 13 is described in detail with reference to the drawing. FIG. 3(A) is an example of image information included in the first image information IMG1-1. As illustrated, in the drawing, image information acquired by imaging a subject S from the front face is illustrated. In the example illustrated in the drawing, the subject S is a face part of a person. FIG. 3(B) is an example of pixel information included in the second image information IMG2. As illustrated, in the drawing, an image having pixels of a color of the rear face of the subject S is illustrated. The pixels of the color of the rear face of the subject S represent the color of the hair of the subject S. The pixels may be estimated from the subject S. In addition, the image illustrated in FIG. 3(B) may be a pattern image (that is, the pattern of the hair) expressing an image of the rear face of the subject S.

FIG. 3(C) is an example of a composed image acquired as a result of an image composing process performed by the image composing unit 13. The image composing unit 13, first, performs a trimming process on a part of the subject S on the basis of the image information included in the first image information IMG1-1. After the trimming process, the image composing unit 13, for a part of the subject S, generates an image in which the image information included in the first image information IMG1-1 and the pixel information included in the second image information IMG2 are alternately provided as a composed image. The image composing unit 13 may alternately compose the image information included in the first image information IMG1-1 and the pixel information included in the second image information IMG2 in a column direction or may alternately compose them in a row direction. In the illustrated example, the image composing unit 13 alternately composes the image information included in the first image information IMG1-1 and the pixel information included in the second image information IMG2 in the column direction. In other words, the image composing unit 13 generates an image in which pixel information for a column or a row in the image information included in the first image information IMG1 and pixel information included in the second image information IMG2 are alternately provided as a composed image.

The image composing unit 13 is not limited to the example of a case in which the information is alternately composed for every one column or for every one row and may alternately compose the information for every multiple columns or for every multiple rows. In addition, the image composing unit 13 is not limited to the example of a case in which the information is alternately composed for every one of the column or the row and may compose the information alternately for any other direction. Furthermore, the image composing unit 13 is not limited to the example of a case in which the information is alternately composed for every predetermined direction and, for example, may alternately compose the information for every pixel, for every multiple pixels, or for every pixel block configured to include a plurality of pixels.

Referring back to FIG. 2, the image composing unit 13 outputs information of the generated composed image to the point cloud data generating unit 14 as a composed image CIMG.

The point cloud data generating unit 14 acquires the first image information IMG1-2 from the first acquisition unit 11 and acquires the composed image CIMG from the image composing unit 13. The point cloud data generating unit generates point cloud data on the basis of the acquired information. Here, the first image information IMG1-2 acquired from the first acquisition unit 11 includes distance information of the front face of the subject S, and the composed image CIMG acquired from the image composing unit 13 includes image information of the front face and the rear face. The point cloud data generating unit 14 generates point cloud data of the font face on the basis of the distance information of the front face of the subject S and the pixel information of the front face portion of the subject S in the composed image CIMG. In addition, the point cloud data generating unit 14 supplements the distance data of the rear face of the subject S and generates point cloud data of the rear face on the basis of the supplemented distance information and the pixel information of the rear face portion of the subject S in the composed image CIMG. The point cloud data generating unit 14 composes the point cloud data of the front face and the point cloud data of the rear face to generate point cloud data of the subject S. The point cloud data generating unit 14 outputs the generated point could data to the output unit 15 as point cloud data PCD.

Here, the process of supplementing the distance information of the rear face portion of the subject S that is performed by the point cloud data generating unit 14 may be performed in accordance with a type of object by performing object detection of the subject S. In addition, in the case of a subject in which the shape of the rear face portion is not significant, the distance information of the rear face portion may be supplemented as a constant value such that the rear face becomes a planar face.

The output unit 15 acquires the point cloud data PCD from the point cloud data generating unit 14 and outputs the acquired point cloud data PCD to an information processing device, a storage device, a display device, or the like, which is not illustrated in the drawing, as a three-dimensional model.

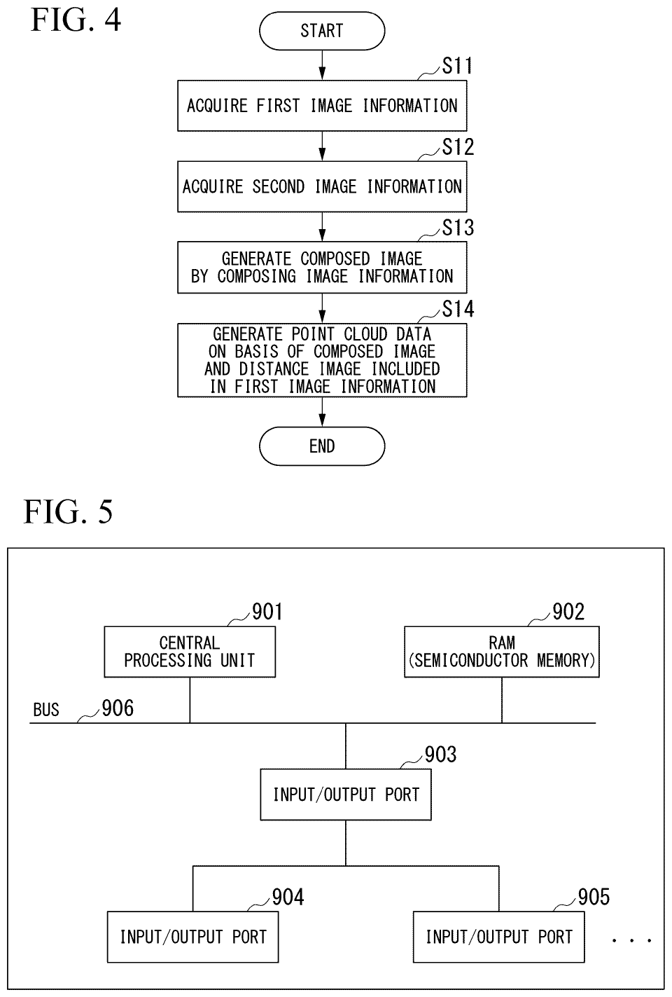

FIG. 4 is a flowchart illustrating an example of a series of operations of the three-dimensional information generating device according to the first embodiment. A series of flows of a three-dimensional information generating process performed by the three-dimensional information generating device 10 are described with reference to the drawing.

First, the first acquisition unit 11 acquires first image information IMG1 in which the image information and the distance information of the front face of a subject S are included from the imaging device 20 (Step S11). Next, the second acquisition unit 12 acquires second image information IMG2 from the storage device 25 (Step S12). The image composing unit 13 generates a composed image CIMG by composing image information on the basis of the first image information IMG1 and the second image information IMG2 that have been acquired (Step S13). The point cloud data generating unit 14 generates point cloud data on the basis of the generated composed image CIMG and the distance image included in the first image information IMG1 (Step S14).

FIG. 5 is a block diagram illustrating an example of an internal configuration of the three-dimensional information generating device 10 according to the first embodiment. At least some of the functions of the three-dimensional information generating device 10 may be realized using a computer. As illustrated in the drawing, the computer is configured to include a central processing unit 901, a RAM 902, an input/output port 903, input/output devices 904, 905, and the like, and a bus 906. The computer can be realized using an existing technology. The central processing unit 901 executes commands included programs read from the RAM 902 and the like. In accordance with each command, the central processing unit 901 writes data into the RAM 902, reads data from the RAM 902, or performs arithmetic operations or logical operations. The RAM 902 stores data and programs. Each element included in the RAM 902 has an address and can be accessed using the address. The RAM is an abbreviation of “Random Access Memory”. The input/output port 903 is a port that is used for the central processing unit 901 to exchange data with an external input/output device and the like. The input/output devices 904 and 905 are input and output devices. The input/output devices 904 and 905 exchange data with the central processing unit 901 via the input/output port 903. The bus 906 is a common communication path that is used inside of the computer. For example, the central processing unit 901 reads/writes data from/into the RAM 902 via the bus 906. For example, the central processing unit 901 accesses the input/output port via the bus 906.

### Summary of First Embodiment

According to the embodiment described above, the three-dimensional information generating device 10 acquires first image information IMG1 including image information acquired by imaging a subject and distance information corresponding to this image information by including the first acquisition unit 11, acquires second image information IMG2 including at least one piece of pixel information by including the second acquisition unit 12, generates a composed image CIMG by composing image information included in the acquired first image information IMG1 and information included in the second image information IMG2 by including the image composing unit 13, and generates point cloud data PCD on the basis of the generated composed image CIMG and distance information included in the first image information IMG1 by including the point cloud data generating unit 14. In other words, according to this embodiment, the three-dimensional shape of a subject S can be easily acquired using one camera.

In addition, according to this embodiment, instead of respectively generating point cloud data of the front face of a subject and point cloud data of the rear face and composing the point cloud data as in a conventional technology, by composing image information having information of the front face and the rear face of the subject S and the distance information, point cloud data PCD is generated. Here, many resources are required for composition of point cloud data. According to this embodiment, composition of point cloud data is not required, and, by composing image data composed in advance and the distance data, the point cloud data PCD of the subject S can be generated using a process that is lighter than that of a conventional technology. In addition, according to this embodiment, since the point cloud data PCD of a subject S can be generated using a light process, even in a case in which the movement of a subject S is desired to be three-dimensionally acquired, the three-dimensional shape of the subject S changing in real time can be acquired.

Furthermore, according to the embodiment described above, the image composing unit 13 generates an image in which pixel information for a column or a row in the image information included in the acquired first image information IMG1 and pixel information included in the second image information IMG2 are alternately provided as a composed image CIMG. This image is an image that is used for generating point cloud data PCD. According to this embodiment, point cloud data PCD representing the three-dimensional shape of a subject S can be easily generated on the basis of the composed image CIMG.

### Second Embodiment

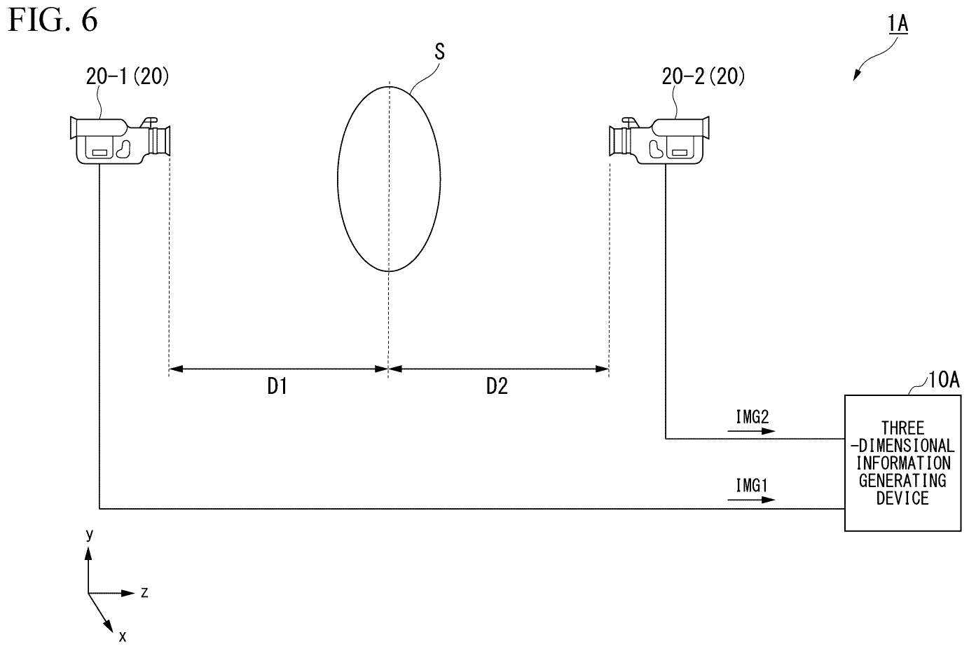

Next, a three-dimensional information generating system 1A according to a second embodiment is described with reference to FIGS. 6 to 10.

FIG. 6 is a functional configuration diagram illustrating an example of a functional configuration of a three-dimensional information acquiring system according to the second embodiment. An example of a functional configuration of the three-dimensional information generating system 1A is described with reference to the drawing.

The three-dimensional information generating system 1A includes a three-dimensional information generating device 10A and a plurality of imaging devices 20. In the following description, an example of a case in which the three-dimensional information generating system 1A includes two imaging devices 20 is described. However, this embodiment is not limited to this example, and the three-dimensional information generating system may include three or more imaging devices 20. In the illustrated example, more specifically, as an example of a plurality of imaging devices 20, a first imaging device 20-1 and a second imaging device 20-2 are illustrated. The three-dimensional information generating system 1A includes two or more imaging devices 20, which is different from the three-dimensional information generating system 1. In addition, the three-dimensional information generating system 1A includes the three-dimensional information generating device 10A in place of the three-dimensional information generating device 10, which is different from the three-dimensional information generating system 1.

By including the three-dimensional information generating device 10A and the plurality of imaging devices 20, the three-dimensional information generating system 1A observes the three-dimensional information of a subject S with multiple viewpoints and generates three-dimensional information of the subject S. More specifically, by including two imaging devices 20 provided at positions facing each other with a subject S interposed therebetween, the three-dimensional information generating system 1A acquires image information and distance information of each of the front face and the rear face of the subject S.

The first imaging device 20-1 images a subject S from a place that is located a first distance D1 away from the subject S in the z-axis direction. The second imaging device 20-2 images a subject S from a place that is located at a position facing the first imaging device 20-1 and is a second distance D2 away from the subject S in the z-axis direction. Positions facing each other are preferably positions at which the optical axis of the first imaging device 20-1 and the optical axis of the second imaging device 20-2 coincide with each other. However, this embodiment is not limited to this example, and the optical axis of the first imaging device 20-1 and the optical axis of the second imaging device 20-2 may be configured to approximately coincide with each other. Here, a range in which the optical axes approximately coincide with each other may be a range, in which the optical axes are approximately parallel to each other, that is allowed as error at the time of generating a three-dimensional shape.

When arithmetic operation to be described below are considered, it is preferable that the first distance D1 and the second distance D2 be the same. However, this embodiment is not limited to this example, and the first distance D1 and the second distance D2 may be distances different from each other. It is assumed that the three-dimensional information generating device 10A stores information relating to the first distance D1 and the second distance D2 in advance.

In the following description, in a subject S, a face on which the first imaging device 20-1 is present may be referred to as a front face of the subject S, and a face on which the second imaging device 20-2 is present may be referred to as a rear face of the subject S. The front face and the rear face of a subject S are not specified from the shape of the subject S and are specified on the basis of a positional relation of the first imaging device 20-1, the second imaging device 20-2, and the subject S. Thus, first image information IMG1 can be regarded to include image information of the front face of the subject S and distance information corresponding to this image information, and second image information IMG2 can be regarded to include image information of the rear face of the subject S and distance information corresponding to this image information.

The first imaging device 20-1 outputs three-dimensional information of the front face of the subject S to the three-dimensional information generating device 10A as the first image information IMG1. The second imaging device 20-2 outputs three-dimensional information of the rear face of the subject S to the three-dimensional information generating device 10A as the second image information IMG2. In addition, the three-dimensional information generating device 10A may estimate a first distance D1 and a second distance D2 on the basis of images captured by the first imaging device 20-1 and the second imaging device 20-2.

The three-dimensional information generating device 10A acquires the first image information IMG1 from the first imaging device 20-1 and acquires the second image information IMG2 from the second imaging device 20-2. The three-dimensional information generating device 10A generates a three-dimensional model having a three-dimensional shape of the subject S on the basis of the first image information IMG1 and the second image information IMG2 that have been acquired. The three-dimensional model generated by the three-dimensional information generating device 10A, for example, may be point cloud data. Here, the three-dimensional information generating system 1A acquires information of the subject S from two directions using two imaging devices 20. Thus, the three-dimensional information generating system 1A can acquire information of the front face of the subject S and information of the rear face. The three-dimensional information generating device 10A generates a three-dimensional model on the basis of the information of the front face of the subject S and the information of the rear face that have been acquired. In this embodiment, in a case in which three or more imaging devices 20 are used, three-dimensional shapes of side faces and upper and lower faces of the subject S may be further acquired.

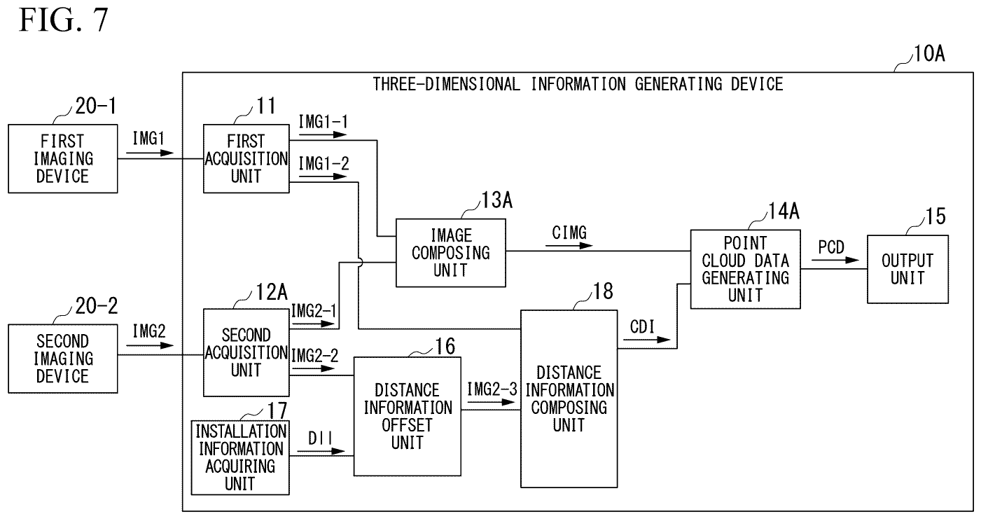

FIG. 7 is a functional configuration diagram illustrating an example of a functional configuration of the three-dimensional information generating device according to the second embodiment. An example of a functional configuration of the three-dimensional information generating device 10A is described with reference to the drawing. The three-dimensional information generating device 10A includes a second acquisition unit 12A in place of the second acquisition unit 12, an image composing unit 13A in place of the image composing unit 13, and a point cloud data generating unit 14A in place of the point cloud data generating unit 14, which is different from the three-dimensional information generating device 10. In addition, the three-dimensional information generating device 10A further includes a distance information offset unit 16, an installation information acquiring unit 17, and a distance information composing unit 18, which is different from the three-dimensional information generating device 10. In description of the three-dimensional information generating device 10A, similar reference signs are assigned to constituent elements that are similar to those of the three-dimensional information generating device 10, and description thereof may be omitted.

The first acquisition unit 11 acquires first image information IMG1 from the first imaging device 20-1. The first image information IMG1 includes at least image information acquired by imaging a subject S from the front face and distance information corresponding to this image information. The first acquisition unit 11 outputs the image information included in the acquired first image information IMG1 to the image composing unit 13A as first image information IMG1-1. In addition, the first acquisition unit 11 outputs the distance information included in the acquired first image information IMG1 to the distance information composing unit 18 as first image information IMG1-2.

The second acquisition unit 12A acquires second image information IMG2 from the second imaging device 20-2. The second image information IMG2 includes at least image information acquired by imaging a subject S from the rear face and distance information corresponding to this image information. The second acquisition unit 12A outputs the image information included in the acquired second image information IMG2 to the image composing unit 13A as second image information IMG2-1. In addition, the second acquisition unit 12A outputs the distance information included in the acquired second image information IMG2 to the distance information offset unit 16 as second image information IMG2-2.

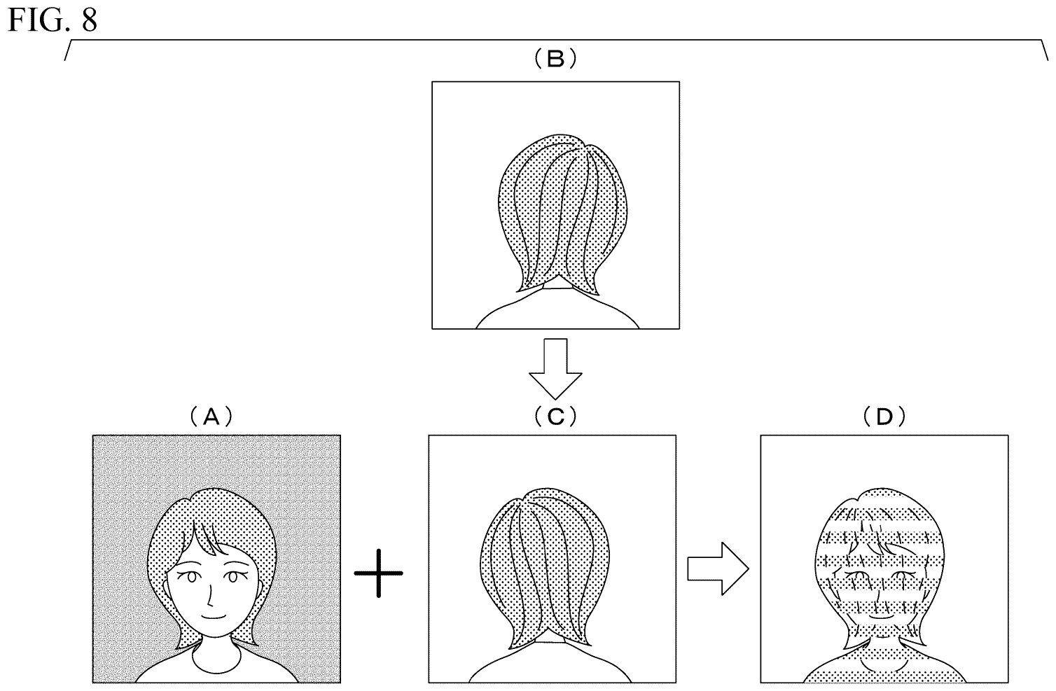

The image composing unit 13A acquires the first image information IMG1-1 from the first acquisition unit 11 and acquires the second image information IMG2-1 from the second acquisition unit 12A. The image composing unit 13A composes the image information included in the acquired first image information IMG1-1 and the image information included in the second image information IMG2-1 to generate a composed image. An example of an image composition method performed by the image composing unit 13A is described in detail with reference to FIG. 8.

FIG. 8 is a diagram showing composition of image information according to the second embodiment. An example of a image composition method performed by the image composing unit 13A is described in detail with reference to the drawing. FIG. 8(A) is an example of image information included in the first image information IMG1-1. As illustrated, in this drawing, image information acquired by imaging a subject S from the front face is illustrated. In the example illustrated in the drawing, the subject S is a face part of a person. FIG. 8(B) is an example of image information included in the second image information IMG2-1. As illustrated, in the drawing, image information acquired by imaging a subject S from the rear face is illustrated.

Here, the image composing unit 13A, first, performs horizontal flip processing on the image information included in the second image information IMG2-1. FIG. 8(C) illustrates an example of a second image information IMG2-1 after the horizontal flip processing has been performed by the image composing unit 13A. In an image composing process, first, by performing horizontal flip on the image of the rear face, the image composing unit 13A can easily perform image composition. The horizontal flip processing is not essential in this embodiment, and direct image composition can be performed using an image before the horizontal flip processing by performing the horizontal flip processing on pixels extracted from an image before the horizontal flip processing. In this case, FIG. 8(B) can be regarded as an auxiliary drawing for the simplification of description.

FIG. 8(D) is an example of a composed image that can be acquired as a result of the image composing process performed by the image composing unit 13A. The image composing unit 13A, first, performs a trimming process on the front face portion of a subject S on the basis of the image information included in the first image information IMG1-1. Next, the image composing unit 13A performs a trimming process on the rear face portion of the subject S on the basis of the image information included in the second image information IMG2-1. The trimming process on the rear face portion may be a process of trimming a similar portion on the basis of a result of the trimming process performed on the front face portion.

After the trimming process is performed, for a part of the subject S, the image composing unit 13A generates an image in which image information included in the first image information IMG1-1 and image information included in the second image information IMG2-1 are alternately provided as a composed image. The image composing unit 13A may alternately compose the image information included in the first image information IMG1-1 and the pixel information included in the second image information IMG2 in a column direction or may alternately compose them in a row direction. In the illustrated example, the image composing unit 13A alternately composes the image information included in the first image information IMG1-1 and the image information included in the second image information IMG2-1 in the column direction. In other words, the image composing unit 13A generates an image in which pixel information for a column or a row in the image information included in the first image information IMG1 and image information included in the second image information IMG2 are alternately provided as a composed image.

The image composing unit 13A is not limited to the example of a case in which the information is alternately composed for every one column or for every one row and may alternately compose the information for every multiple columns or for every multiple rows. In addition, the image composing unit 13A is not limited to the example of a case in which the information is alternately composed for every one of the column or the row and may compose the information alternately for any other direction. Furthermore, the image composing unit 13A is not limited to the example of a case in which the information is alternately composed for every predetermined direction and, for example, may alternately compose the information for every pixel, for every multiple pixels, or for every pixel block configured to include a plurality of pixels.

Referring back to FIG. 7, the image composing unit 13A outputs information of the generated composed image to the point cloud data generating unit 14A as a composed image CIMG.

The installation information acquiring unit 17 acquires information relating to a distance between a place at which the first imaging device 20-1 capturing the first image information IMG1 is installed and a place at which the second imaging device 20-2 capturing the second image information IMG2 is installed. In other words, this distance is a distance acquired by adding a first distance D1 and a second distance D2. The installation information acquiring unit 17 may individually acquire the first distance D1 and the second distance D2 independently or may acquire the distances as one piece of distance information.

The distance information offset unit 16 acquires second image information IMG2-2 from the second acquisition unit 12A. In addition, the distance information offset unit 16 acquires information relating to a distance between a place at which the first imaging device 20-1 capturing the first image information IMG1 is installed and a place at which the second imaging device 20-2 capturing the second image information IMG2 is installed, that is, information relating to a distance acquired by adding the first distance D1 and the second distance D2 from the installation information acquiring unit 17. The distance information offset unit 16 converts the distance information acquired by the second imaging device 20-2, that is, information of a distance from the second imaging device 20-2 to the subject S into information of a distance from the position of the first imaging device 20-1 to the subject S. Hereinafter, a distance information conversion process performed by the distance information offset unit 16 may be referred to as an offset process.

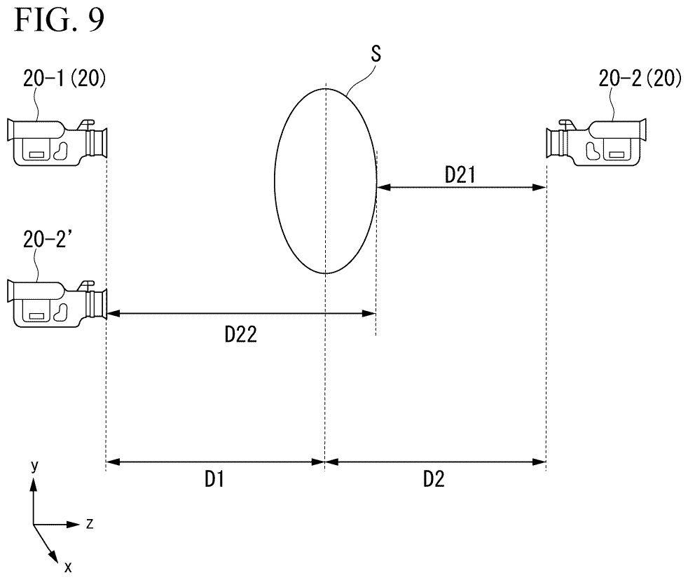

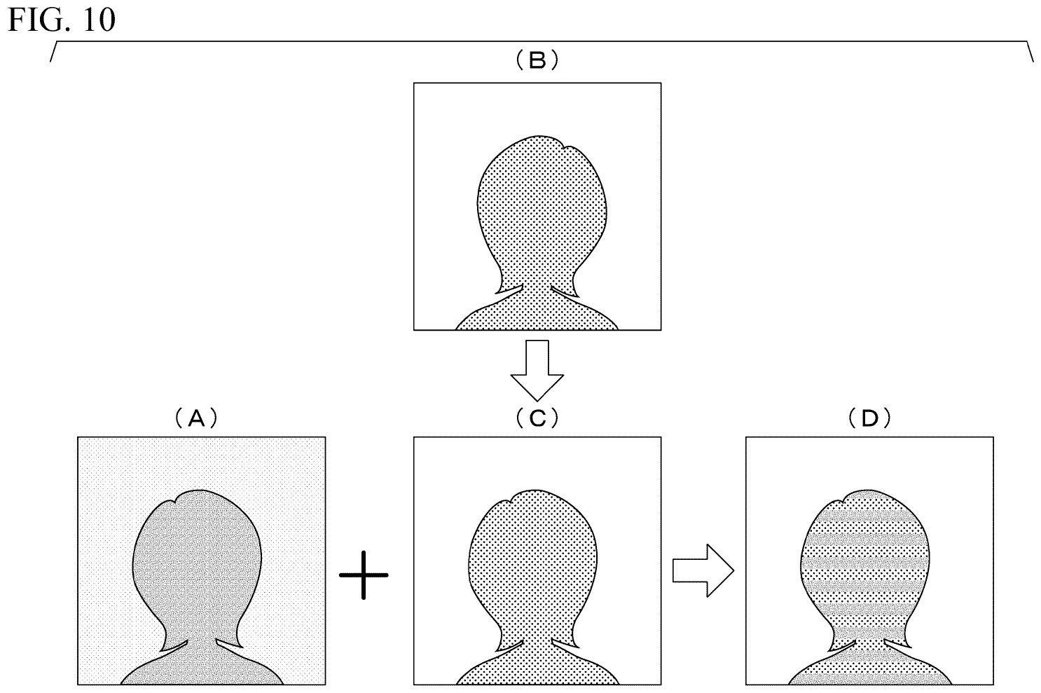

FIG. 9 is a diagram showing an offset of distance information according to the second embodiment. An offset process performed by the distance information offset unit 16 is described with reference to the drawing. In the drawing, a positional relation of the first imaging device 20-1, the second imaging device 20-2, and a subject S is represented. A distance from the first imaging device 20-1 to the center position of the subject S is a first distance D1, and a distance from the second imaging device 20-2 to the center position of the subject S is a second distance D2.

Here, a distance from the second imaging device 20-2 to the subject S is a distance D21. The distance information offset unit 16 converts the distance D21 into a distance D22 as if it were captured by an imaginary second imaging device 20-2′ present at the same position as the first imaging device 20-1 on the z axis. A conversion equation from the distance D21 to the distance D22 is represented using the following Equation (1).

Distance D22=(Second distance D2−Distance D21)+First distance D1 (1)

The distance information offset unit 16 performs an offset process based on Equation (1) for each coordinates on the z-y plane. Referring back to FIG. 7, the distance information offset unit 16 outputs information acquired as a result of the offset process to the distance information composing unit 18 as second image information IMG2-3.

The distance information composing unit 18 acquires the first image information IMG1-2 from the first acquisition unit 11 and acquires the second image information IMG2-3 from the distance information offset unit 16. The distance information composing unit 18 composes the distance information included in the acquired first image information IMG1-2 and the distance information included in the second image information IMG2-3, thereby generating a composed distance image CDI.

FIG. 10 is a diagram showing composition of distance images according to the second embodiment. An example of a distance information composition method performed by the distance information composing unit 18 is described in detail with reference to the drawing. FIG. 10(A) is an example of a distance information included in the first image information IMG1-2. As illustrated, in the drawing, information of a distance image acquired by imaging a subject S from the front face is represented. In the example illustrated in the drawing, the subject S is a face part of a person. In other words, the first image information IMG1-2 includes information of a distance image of the front face of the subject S that is the face of a person. FIG. 10(B) is an example of a distance information included in the second image information IMG2-3. As illustrated, in the drawing, information of a distance image acquired by imaging a subject S from the rear face is represented. In the example illustrated in the drawing, since the subject S is a face part of a person, the second image information IMG2-3 includes information of a distance image of the rear face of the subject S that is the face of a person.

Here, the distance information composing unit 18, first, performs horizontal flip processing on a distance image included in the second image information IMG2-3. FIG. 10(C) illustrates an example of a second image information IMG2-3 after horizontal flip processing using the distance information composing unit 18. In a distance information composing process, the distance information composing unit 18, first, can easily perform the distance information composing process by performing horizontal flip of the distance image of the rear face. The horizontal flip processing is not essential in this embodiment, and a direct distance image composing process can be performed using a distance image before the horizontal flip processing by performing the horizontal flip processing on distance information extracted from the distance image before the horizontal flip processing. In this case, FIG. 8(B) can be regarded as an auxiliary drawing for the simplification of description.

FIG. 10(D) is an example of a composed distance image acquired as a result of a distance information composing process performed by the distance information composing unit 18. The distance information composing unit 18, first, performs a trimming process on the front face portion of the subject S on the basis of the distance image included in the first image information IMG1-2. Next, the distance information composing unit 18 performs a trimming process on the rear face portion of the subject S on the basis of the distance image included in the second image information IMG2-3. The trimming process on the rear face portion may be a trimming process of a similar portion on the basis of the result of the trimming process on the front face portion. After the trimming process, the distance information composing unit 18 generates a distance image in which the distance information included in the first image information IMG1-2 and the distance information included in the second image information IMG2-3 are alternately provided as a composed distance image. The distance information composing unit 18 may alternately compose the distance information included in the first image information IMG1-2 and the distance information included in the second image information IMG2-3 in a column direction or may alternately compose them in a row direction. In the illustrated example, the distance information composing unit 18 alternately composes the distance information included in the first image information IMG1-2 and the distance information included in the second image information IMG2-3 in the column direction. In other words, the image composing unit 13A generates an image in which distance information for a column or a row in the distance information included in the first image information IMG1 and distance information included in the second image information IMG2 are alternately provided as a composed image. Here, it is preferable that the direction of composition (that is, alternate composition in the row direction or the like) performed by the distance information composing unit 18 should be the same as the direction of composition performed by the image composing unit 13A.

Referring back to FIG. 7, the distance information composing unit 18 outputs information of the composed distance image to the point cloud data generating unit 14A as a composed distance image CDI.

The point cloud data generating unit 14A acquires the composed image CIMG from the image composing unit 13A and acquires the composed distance image CDI from the distance information composing unit 18. The point cloud data generating unit 14A generates point cloud data on the basis of the acquired information. Here, the composed image CIMG acquired from the image composing unit 13A includes image information of the front face and the rear face, and the composed distance image CDI acquired from the distance information composing unit 18 includes distance information of the front face and the rear face. Thus, the point cloud data generating unit 14A can generate point group data having the three-dimensional shape of the entire subject S on the basis of the composed image CIMG and the composed distance image CDI. The point cloud data generating unit 14A outputs the generated point cloud data to the output unit 15 as point could data PCD.

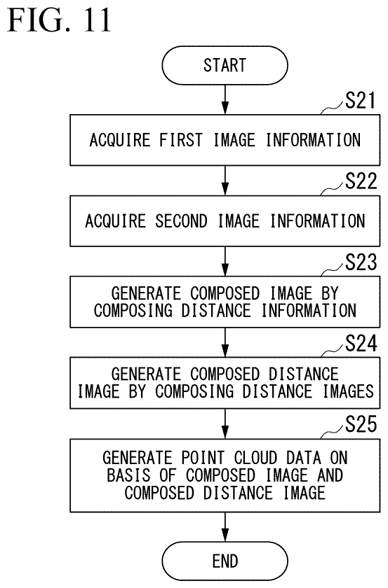

FIG. 11 is a flowchart illustrating an example of a series of operations of the three-dimensional information generating device according to the second embodiment. A series of flows of a three-dimensional information generating process performed by the three-dimensional information generating device 10A are described with reference to the drawing.

First, the first acquisition unit 11 acquires first image information IMG1 in which the image information and the distance information of the front face of a subject S are included from the imaging device 20-1 (Step S21). Next, the second acquisition unit 12A acquires the second image information IMG2 including image information and distance information of the rear face of the subject S from the second imaging device 20-2 (Step S22). The image composing unit 13A generates a composed image CIMG by composing image information on the basis of the first image information IMG1 and the second image information IMG2 that have been acquired (Step S23). The distance information composing unit 18 generates a composed distance image CDI by composing distance information on the basis of the first image information IMG1 and the second image information IMG2 that have been acquired (Step S24). The point cloud data generating unit 14A generates point cloud data on the basis of the composed image CIMG and the composed distance image CDI that have been generated (Step S25).

### Summary of Second Embodiment

According to the embodiment described above, the second image information IMG2 acquired by the second acquisition unit 12A includes image information acquired by imaging a subject S from a direction (for example, the rear face) different from that of the image information included in the first image information IMG1 and distance information corresponding to this image information. In addition, by further including the distance information composing unit 18, the three-dimensional information generating device 10A composes the distance information included in the acquired first image information IMG1 and the distance information included in the second image information IMG2 to generate a composed distance image CDI. Furthermore, the point cloud data generating unit 14A generates point cloud data PCD on the basis of the composed image CIMG and the composed distance image CDI that have been generated. In other words, according to this embodiment, the three-dimensional shape of the rear face of a subject S can be acquired as well. Thus, according to this embodiment, the three-dimensional shape of a subject S can be acquired with high accuracy.

In addition, according to this embodiment, instead of respectively generating point cloud data of the front face of a subject and point cloud data of the rear face and composing the point cloud data as in a conventional technology, by composing image information having information of the front face and the rear face of the subject S and the distance information, point cloud data PCD is generated. Thus, according to this embodiment, point cloud data PCD of a subject S can be generated using a light process. In addition, according to this embodiment, since the point cloud data PCD of a subject S can be generated using a light process, even in a case in which the movement of a subject S is desired to be three-dimensionally acquired, the three-dimensional shape of the subject S changing in real time can be acquired.

Furthermore, according to the embodiment described above, by including the installation information acquiring unit 17, information relating to a distance between a place at which the first imaging device 20-1 capturing the first image information IMG1 is installed and a place at which the second imaging device 20-2 capturing the second image information IMG2 is installed is acquired. In addition, the distance information composing unit 18 generates a distance image in which distance information in the column or row direction in the distance information included in the acquired first image information IMG1 and distance information acquired by subtracting distance information in the column or row direction in the distance information included in the second image information IMG2 from the distance acquired by the installation information acquiring unit 17 are alternately provided as a composed distance image CDI. In other words, according to this embodiment, distance information acquired from the rear face of the subject S is converted into distance information from the front face of the subject S, and a composed distance image CDI having distance information of the front face and the rear face of the subject S, which is seen from the front face of the subject S, is generated. According to the three-dimensional information generating device 10A, point cloud data is generated on the basis of the composed image CIMG having the image information of the front face and the rear face of the subject S and the composed distance image CDI having distance information of the front face and the rear face of the subject S. Thus, according to this embodiment, point cloud data can be easily generated using a light process.

In addition, according to the embodiment described above, the image composing unit 13A generates a composed image CIMG by composing the image information included in the acquired first image information IMG1 and image information acquired by horizontally flipping the image information included in the second image information IMG2, and, furthermore, the distance information composing unit 18 generates a composed distance image CDI by composing the distance information included in the acquired first image information IMG1 and image information acquired by horizontally flipping the distance information included in the second image information IMG2. Thus, according to this embodiment, the image information and the distance information of the front face and the rear face can be easily composed respectively.

In addition, according to the embodiment described above, the three-dimensional information generating system 1A captures the first image information IMG1 including image information acquired by imaging a subject S in the first direction and distance information corresponding to this image information by including the first imaging device 20-1, captures the second image information IMG2 including image information acquired by imaging the subject S in the second direction and distance information corresponding to this image information by including the second imaging device 20-2, and generates three-dimensional information of the subject S on the basis of the first image information IMG1 and the second image information IMG2 by including the three-dimensional information generating device 10A. In addition, the three-dimensional information generating device 10A acquires the first image information IMG1 by including the first acquisition unit 11, acquires the second image information IMG2 by including the second acquisition unit 12A, generates a composed image CIMG on the basis of the image information included in the acquired first image information IMG1 and the image information included in the second image information IMG2 by including the image composing unit 13A, generates a composed distance image CDI on the basis of the distance information included in the acquired first image information IMG1 and the distance information included in the second image information IMG2 by including the distance information composing unit 18, and generates point cloud data PCD on the basis of the composed image CIMG and the composed distance image CDI generated by including the point cloud data generating unit 14A. The first imaging device 20-1 and the second imaging device 20-2 are installed at positions facing each other. In other words, according to this embodiment, the three-dimensional shape of a subject S is acquired using two imaging devices 20 that face each other. Thus, according to this embodiment, a three-dimensional shape with high accuracy can be measured in real time using a small number of imaging devices 20.

All or some of the functions of each unit of each device according to the embodiment described above may be realized by recording a program used for realizing such functions on a computer-readable recording medium and causing a computer system to read and execute the program recorded on this recording medium. A “computer system” described here includes an OS and hardware such as peripheral devices.

A “computer-readable recording medium” represents a storage unit including a portable medium such as a flexible disk, a magneto-optical disc, a ROM, or a CD-ROM, a hard disk built into a computer system, and the like. Furthermore, a “computer-readable recording medium” may include a medium that dynamically stores a program during a short time interval such as a communication line of a case in which a program is transmitted via a network such as the Internet or a telephone line and a medium that stores a program for a predetermined time such as an internal volatile memory of a computer system serving as a server or a client in that case. In addition, the program described above may be used for realizing a part of the functions described above and, furthermore, may be a program that can realize the functions described above by being combined with a program recorded in the computer system in advance.

As above, although the embodiments of the present invention have been described, the present invention is not limited to the embodiments described above, and various modifications can be applied in a range not departing from the concept of the present invention. Furthermore, the embodiments described above may be appropriately combined.

According to the present invention, the three-dimensional shape of a subject can be easily acquired using a smaller number of cameras.

### REFERENCE SIGNS LIST

1, 1A Three-dimensional information generating system
10, 10A Three-dimensional information generating device
20 Imaging device
S Subject
SCR Screen
IMG1 First image information
11 First acquisition unit
12 Second acquisition unit
13 Image composing unit
14 Point cloud data generating unit
15 Output unit
25 Storage device
CIMG Composed image
PCD Point cloud data
IMG2 Second image information
16 Distance information offset unit
17 Installation information acquiring unit
18 Distance information composing unit
CDI Composed distance image
DII Installation information

What is claimed is:

1. A three-dimensional information generating device comprising:
a first acquisition unit configured to acquire first image information including image information acquired by imaging a subject and distance information corresponding to this image information;
a second acquisition unit configured to acquire second image information including at least pixel information;
an image composing unit configured to generate a composed image by composing the image information included in the acquired first image information and information included in the second image information; and
a point cloud data generating unit configured to generate point cloud data on the basis of the generated composed image and the distance information included in the first image information,
wherein the image composing unit generates an image in which pixel information of a column or a row in the image information included in the acquired first image information and the pixel information included in the second image information are alternately provided as the composed image.

2. The three-dimensional information generating device according to claim 1, further comprising a distance information composing unit configured to generate a composed distance image by composing the distance information included in the acquired first image information and distance information included in the second image information,
wherein the second image information includes image information acquired by imaging the subject in a direction different from a direction in which the subject has been imaged in the image information included in the first image information and distance information corresponding to this image information.

3. The three-dimensional information generating device according to claim 2, further comprising an installation information acquiring unit configured to acquire information relating to a distance between a place at which a first imaging device imaging the first image information is installed and a place at which a second imaging device imaging the second image information is installed,
wherein the distance information composing unit generates a distance image in which distance information of a column or row direction in the distance information included in the first acquired first image information and distance information acquired by subtracting distance information of a column or row direction in distance information included in the second image information from the distance acquired by the installation information acquiring unit are alternately provided as the composed distance image.

4. A three-dimensional information generating method executed by a three-dimensional information generating device, the three-dimensional information generating method comprising:
a first acquisition process of acquiring first image information including image information acquired by imaging a subject and distance information corresponding to this image information;
a second acquisition process of acquiring second image information including at least pixel information;
an image composing process of generating a composed image by composing the image information included in the acquired first image information and information included in the second image information; and
a point cloud data generating process of generating point cloud data on the basis of the generated composed image and the distance information included in the first image information,
wherein the image composing process generates an image in which pixel information of a column or a row in the image information included in the acquired first image information and the pixel information included in the second image information are alternately provided as the composed image.
